(19) United States
(12) Patent Application Publication
(10) Pub. No.: US 2007/0177187 A1
(43) Pub. Date: Aug. 2, 2007

(54) Print system and print apparatus

(76) Inventor: Kenji Hisatomi, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/591,256

(22) PCT Filed: Jun. 24, 2005
(86) PCT No.: PCT/JP05/11644

§ 371 Date: Aug. 31, 2006

(30) Foreign Application Priority Data
Jun. 24, 2004 (JP) 2004-187000

(51) Int. Cl. G06F 3/12

(52) U.S. Cl. 358/1.15; 358/1.14

(57) ABSTRACT

The present invention provides a print system that can avoid the case where a sheet of photo paper is wastefully used in printing.

When an instruction from a user includes an instruction specific to photo printing (an instruction to use a sheet of photo paper, for example) (S203), a host apparatus appends a tag indicating “photo printing” to print content to be transmitted to a printer (S206). When the printer receives the print content from the host apparatus (S251) and the image data included in the received print content cannot be used for the printing (S252: Yes), the printer changes the details of the printing operation as appropriate (S254, S255, and S256) on the basis of the presence or absence of the appended tag (S253), thereby avoiding the case where a sheet of photo paper is wasted.

### TECHNICAL FIELD

The present invention relates to a print system for printing print content that includes image data of an image shot by an electronic image pickup device or the like typified by a digital still camera (referred to as the “DSC” hereafter) or that includes image data received via a digital television receiver (referred to as the “DTV” hereafter). In particular, the present invention relates to a print apparatus or the like which receives the print content and rasterizes it as appropriate for printing.

### BACKGROUND ART

In recent years, DSCs (also referred to as “digital still cameras” or “digital cameras”) have become widely used. A DSC photoelectrically converts an object image formed by an optical lens into an electric signal using an image pickup device such as a CCD, generates image data compressed according to the JPEG (Joint Photographic Experts Group) format or the like on the basis of the electric signal, and records the data in a card medium such as a memory card or in a recording medium such as a built-in fixed memory. Moreover, there are printers coming along that print an image on a paper medium or the like using image data generated by such a DSC or the like. Also, there are printers that print an image on a paper medium or the like using image data received via a digital television receiver or the like.

When the stated conventional printer cannot perform printing due to some kind of trouble relating to the image data (decoding disabled or image data access disabled, for example), a sheet of paper is fed with its page being left blank or paper feeding itself is not carried out. This is because the main purpose of the stated printer is to print the image data and, therefore, there is little point in printing alternative characters or the like.

Meanwhile, there are HTML (Hyper Text Markup Language) browsers and the like coming along that display an HTML description file that describes print content including the image data as a part.

The HTML browser lays out an image and text in accordance with the details of the file described in the HTML format and displays them on a monitor. Here, when the image cannot be displayed due to some kind of trouble relating to the image data, alternative characters may be displayed in place of the image.
Patent Reference 1: Japanese Application Publication No. 2003-209797.

### DISCLOSURE OF INVENTION

### Problems that Invention is to Solve

However, recent years have also seen a method proposed for a print system in which image data is transmitted for printing from a DSC or the like to a printer. Using this system, the DSC side generates an ML description file that is described in an ML language and that includes the image data whereas the printer side interprets the received ML description file and performs layout. The printing is then carried out on the basis of the result of this layout.

FIG. 1 is a schematic diagram to explain about a problem with the print system proposed in recent years. As shown by <CASE A> in FIG. 1, when image data generated by a conventional DSC is normal, the image can be normally printed on a sheet of photo paper as a matter of course. On the other hand, when the image data generated by the conventional DSC is abnormal as shown by <CASE B>, the printing to be performed on a sheet of photo paper is aborted and a user is notified by the blinking of an LED or the like that the printing is disabled.

Meanwhile, as shown by <CASE C>, even when image data generated (or acquired) by a conventional personal computer (abbreviated as the “PC” hereafter) is abnormal, the printing is not aborted and only “text” is printed because a print medium is plain paper which is less costly (this is also because there may be cases where the amount of information in the text is large).

However, as shown by <CASE D> proposed in recent years as mentioned above, when print content is made up of image data and an ML description file and the photo printing cannot be performed due to the abnormal image data as described above, there is little point in printing alternative characters or the like as were printed in the above case of the HTML browser. If anything, paper used for photo printing is usually expensive photo paper and to print meaningless alternative characters on such photo paper is a waste, which may cause a problem.

Nevertheless, whether or not the print content is to be used for photo printing cannot be determined only by that the ML description file is included in the print content.

With this being the situation, the present invention was conceived in view of the stated problem and an object of the present invention is to provide a print system which can avoid cases where photo paper is wastefully used in photo printing.

### Means to Solve the Problems

In order to achieve the object, the print system of the present invention is made up of: a print content generation unit operable to generate or acquire print content that includes a control code and image data; an image data determination unit operable to determine whether or not the image data included in the generated or acquired print content can be used for printing; a photo printing judgment unit operable to judge whether or not the printing to be performed using the print content is intended for photo printing; and a printing control unit operable to change details of printing processing in accordance with a determination result given by the image data determination unit and a judgment result given by the photo printing judgment unit.

With this, the details of the printing processing is changed on the basis of whether or not the image data can be used for the printing and whether or not the photo printing is intended. Thus, it becomes possible to perform the printing more in accordance with a desire of the user.

Moreover, the printing control unit may be operable to abort the printing to be performed using the print content, when the image data determination unit determines that the image data cannot be used for the printing and the photo printing judgment unit judges that the photo printing is intended.

With this, when the image data cannot be used for the printing and the photo printing is intended, the printing is aborted. On account of this, it is possible to avoid a waste of costly photo paper.

It should be noted that the present invention can also be realized as: a print method which has steps corresponding to the characteristic units provided in the stated print apparatus; and a program which causes a personal computer or the like to execute these steps. Also, it should be understood that such a program can be distributed via a recording medium such as a DVD or via a transmission medium such as the Internet.

### Effects of the Invention

Owing to the present invention, when it is highly probable that photo printing is intended but image data cannot be used for the printing, the processing, such as abortion of the printing, feeding of a blank sheet of paper, or no paper feeding at all, is performed. Accordingly, costly photo paper can be prevented from being wasted.

When the print content is anything other than photos and the image data is abnormal, the printer prints the rest of the content as much as possible by replacing the part of the image data with alternative characters. Therefore, the user can obtain the print result which is as close to normal as possible.

### BRIEF DESCRIPTION OF DRAWINGS

FIG. 1 is a schematic diagram to explain about a problem with a print system proposed in recent years.

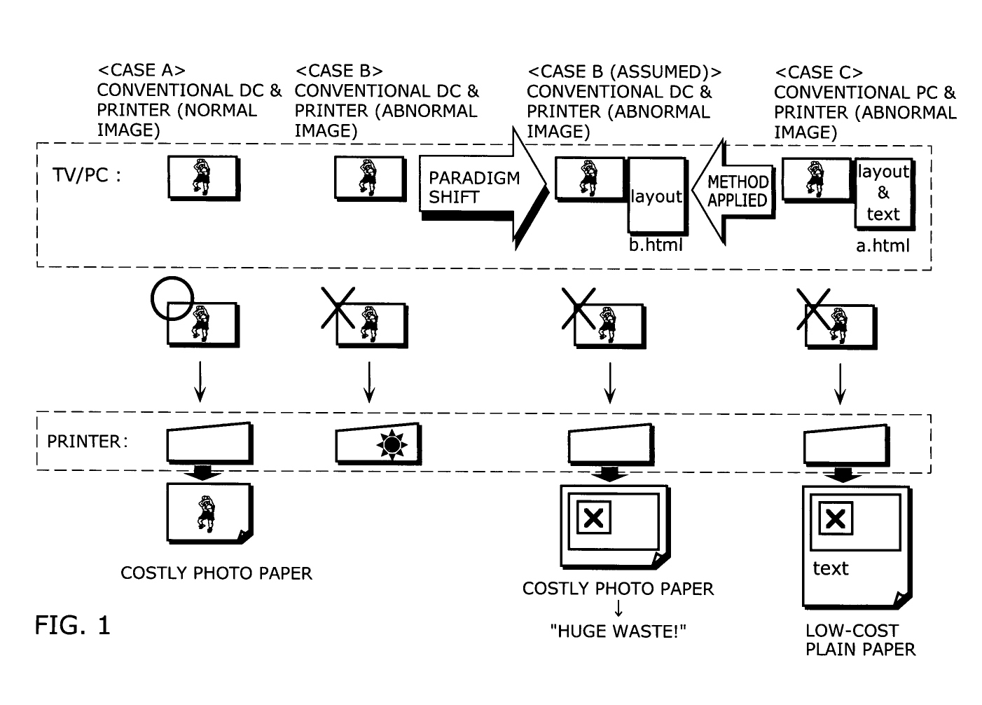

FIG. 2 is a block diagram showing a function structure of a print system of a first embodiment.

FIG. 3 is a flowchart showing a flow of processing performed by the print system of the first embodiment.

FIG. 4(a) is a diagram showing an example of a file described in a description language in the first embodiment. FIG. 4(b) is a diagram showing an example of image data in the first embodiment. FIG. 4(c) is a diagram showing an example of a print result in a case where the printing is normally performed on the basis of the examples shown in FIGS. 4(a) and 4(b).

FIG. 5 is a block diagram showing a function structure of a print system of a second embodiment.

FIG. 6 is a flowchart showing a flow of processing performed by the print system of the second embodiment.

FIG. 7(a) is a diagram showing an example of a file described in a description language in a third embodiment. FIG. 7(b) is a diagram showing an example of image data in the third embodiment. FIG. 7(c) is a diagram showing an example of a print result in a case where the printing is normally performed on the basis of the examples shown in FIGS. 7(a) and 7(b).

FIG. 8 is a block diagram showing a function structure of a print system of the third embodiment.

FIG. 9 is a flowchart showing a flow of processing performed by the print system of the third embodiment.

FIG. 10 is a block diagram showing a function structure of a print system of a fourth embodiment.

FIG. 11 is a flowchart showing a flow of processing performed by the print system of the fourth embodiment.

FIG. 12 is a flowchart showing a flow of processing performed by a print system of a fifth embodiment.

FIG. 13 is a flowchart showing details of photo printing detection processing 1 in the fifth embodiment.

FIG. 14 is a flowchart showing details of photo printing detection processing 2 in the fifth embodiment.

### NUMERICAL REFERENCES

| | |
|---|---|
| 100, 400, 900 | DTV |
| 101 | processing control unit |
| 102 | input instruction determination unit |
| 103 | print content generation unit |
| 104, 953 | photo printing judgment unit |
| 105 | transmission/reception unit |
| 106 | memory card reader |
| 150, 450, 750, 950 | printer |
| 151 | transmission/reception unit |
| 152 | image data determination unit |
| 153 | photo tag judgment unit |
| 154 | printing unit |
| 155 | printing control unit |
| 404 | digital camera tag appending unit |
| 453 | digital camera tag judgment unit |
| 706 | printer state acquisition unit |
| 756 | printer state reporting unit |

### BEST MODE FOR CARRYING OUT THE INVENTION

The following is a description of embodiments of the present invention, with reference to the drawings. It should be noted that although the present invention will be explained with reference to the drawings, the object of these drawings is to show specific examples and, therefore, the present invention is not limited to these.

### (FIRST EMBODIMENT)

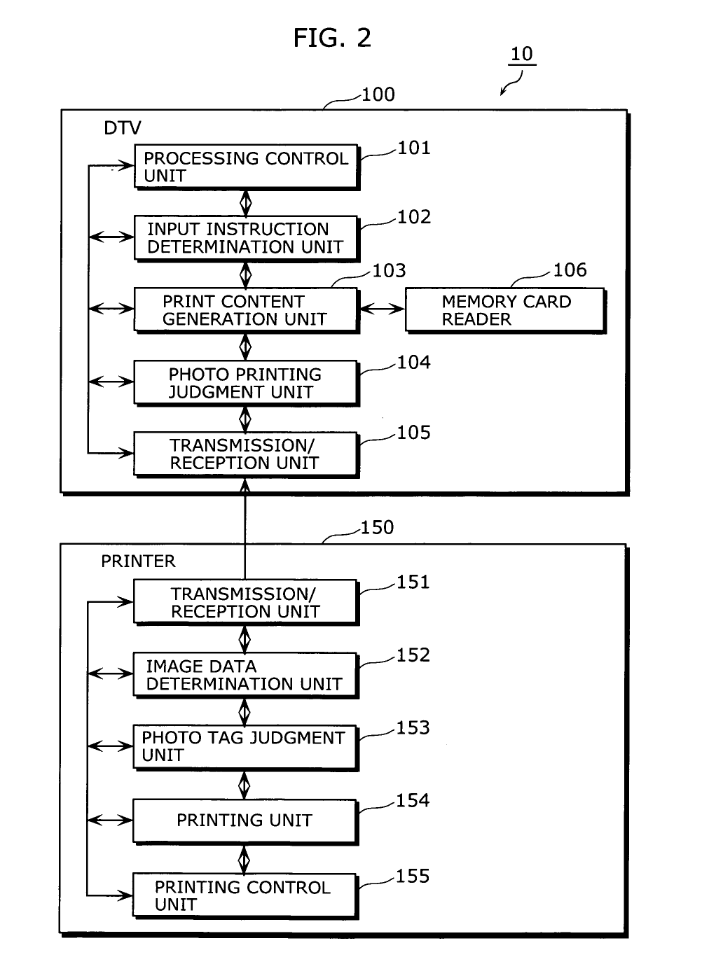

FIG. 2 is a block diagram showing a function structure of a print system 10 of the present embodiment. The present print system (may also be referred to as the “image processing system” hereafter) 10 is a print system which allows printing to be performed on a sheet of paper, such as photo paper and plain paper, on the basis of print content including image data that is described in conformity with a predetermined description language (description languages such as HTML and XHTML). In particular, this system allows printing to be performed using an “instruction to change the printing operation of the printer” that is described in the format of a markup language (referred to as the “ML” hereafter). As shown in FIG. 2, the print system 10 is composed of a digital television receiver (referred to as the “DTV” hereafter) 100 and a printer 150.

It should be noted that although the DTV 100 is described as an example of an apparatus for outputting the print content to the printer 150, it is not necessarily limited to the DTV. It may be an STB (Set Top Box) or another apparatus that is capable of generating image data for photo printing, such as a DSC, a PDA, or a camera cellular phone. Alternatively, it may be an apparatus that is used as photo storage, such as a PC or an HDD recorder, for storing the image data. Here, the “photo printing” refers to printing processing in which printing on a sheet of photo paper is intended (or, borne in mind).

The DTV 100 is an apparatus for converting print content including image data that was acquired (or generated) via an antenna (not illustrated) or a memory card reader 106 into a predetermined format and then transmitting the content to the printer 150 and a monitor (not illustrated). The DTV 100 is composed of a processing control unit 101, an input instruction determination unit 102, a print content generation unit 103, a photo printing judgment unit 104, and a transmission/reception unit 105.

The processing control unit 101 is a microcomputer provided with a RAM and a ROM, for example, and controls each unit of the DTV 100.

The input instruction determination unit 102 analyzes the details of an instruction received from the user via a switch (not illustrated) or the like, and notifies the processing control unit 101 of the result.

The print content generation unit 103 generates print content described in the ML format for printing using the image data acquired via the antenna or the memory reader 106, according to the instruction from the user.

The photo printing judgment unit 104 judges whether or not printing of the print content generated by the print content generation unit 103 is intended for photo printing. When judging that the photo printing is intended, the photo printing judgment unit 104 appends an ML tag (photo tag) indicating so to the print content.

The transmission/reception unit 105 exchanges the print content and commands between the DTV 100 and the printer 150.

The printer 150 is an apparatus that prints images and text on a print medium, such as a sheet of photo paper, on the basis of the print content received from the DTV 100. The printer 150 is composed of a transmission/reception unit 151, an image data determination unit 152, a photo tag judgment unit 153, a printing unit 154, and a printing control unit 155.

The transmission/reception unit 151 exchanges the print content and print commands between the DTV 100 and the transmission/reception unit 105.

The image data determination unit 152 sequentially analyzes each line described in the ML language for printing, and checks whether or not the image data necessary for the printing can be printed (or, whether or not the image data is abnormal). As a method of this check, the image data determination unit 152 attempts to acquire the image data from the DTV 100 and checks whether or not the image data is actually acquirable. To be more specific, the image data determination unit 152 refers to a URI (Uniform Resource Identifier) showing the location of the image data and makes a request to the DTV for the present image data. When the image data cannot be acquired for some reason, such as: no communication with the DTV; no right granted to access the present image data; absence of the present image data; the DTV powered off; or the DTV being processing some other task, the image data determination unit 152 judges that the image data cannot be printed. Alternatively, the image data determination unit 152 refers to information attached to the acquired image data and checks whether or not the printing is permitted. Or, the image data determination unit 152 checks whether or not the format of the image data can be interpreted by the printer 150. To be more specific, the image data determination unit 152 extracts the part of a filename extension of the image data from the URI of the image data, and verifies the extension against an extension list which contains extensions of image data that can be treated by the printer 150. Moreover, as another method, the image data determination unit 152 extracts the part of a header or the like of the acquired image data and checks whether or not the image data can be treated by the printer 150. Alternatively, the image data determination unit 152 checks whether or not the image data is abnormal. To be more specific, since the printer 150 has a non-illustrated image decoding unit which performs processing to decompress the image data compressed as in the case of the JPEG format, the present acquired image data is inputted into this image decoding unit so that the decompression processing is performed. When the resultant output is an “error in the decompression processing”, the image data judgment unit 152 judges that the present image data cannot be printed.

The photo tag judgment unit 153 checks whether or not a photo tag is described in the print content.

The printing unit 154 converts the print content into a print image and prints it on a print medium, such as a sheet of photo paper, at a predetermined resolution (200 dpi, 300 dpi, or 400 dpi, for example). As a type of printing method in this case, there are thermal type, thermal transfer type, dye sublimation type, and ink-jet type.

The printing control unit 155 is a microcomputer provided with a RAM and a ROM, for example. The printing control unit 155 controls each unit of the printer 150 as well as changing the details of the printing processing on the basis of the determination results given by the image data determination unit 152 and the photo tag judgment unit 153.

It should be noted that the DTV 100 and the printer 150 are connected to each other via an IEEE 1394 bus or a USB, and that respective interface means of these apparatuses exchange data in accordance with the specifications of the bus used for the connection.

Next, an explanation is given as to an operation performed by the image processing system that is structured as described so far.

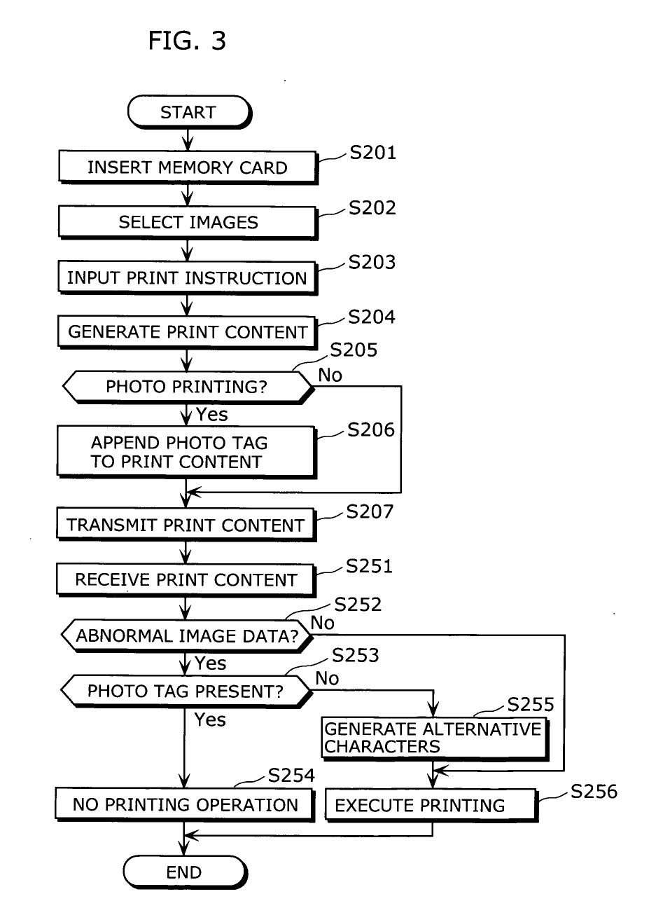

FIG. 3 is a flowchart showing a flow of processing performed by the print system 10 of the present embodiment.

When the user inserts a memory card storing image data into the memory card reader 106 of the DTV 100 (S201), the processing control unit 102 reads the image data stored in the memory card through an application for photo printing (a photo viewer application, for example), then presents the present image on a display unit (not illustrated). It should be noted that the photo printing judgment unit 104 judges whether or not the application currently being run is an application for photo printing by verifying the present application against a photo application database (not illustrated) in which names of photo printing applications are stored as a list. After this, the processing control unit 101 specifies one or more images as print objects on the basis of an instruction received via the input instruction determination unit 102 (S202).

Next, the input instruction determination unit 102 receives an instruction for “printing one image per sheet of paper (namely, a print medium)” via a non-illustrated print instruction button on the screen of the DTV 100 (S203). Then, the print content generation unit 103 generates print content which describes an instruction to lay out for photo printing per sheet of paper (S204). In this case, the print content is generated on the basis of information, such as: a file path and a file name used for referencing to the image data; and shooting data and time. At that time, the photo printing judgment unit 104 judges that the present printing is intended for photo printing, from that the input instruction determination unit 102 received the instruction for “printing one image per sheet of paper” using the application for photo printing (S205). It should be noted that the intention of photo printing may be judged only by the application or may be judged only by the instruction for “printing one image per sheet of paper”. When the photo printing is judged to be intended (S205: Yes), a photo tag used for indicating the photo printing to the printer 150 is described in the print content (S206).

It should be noted that there is another method for judging whether or not the photo printing is intended. When an instruction for a print setting is received from the user via the input instruction determination unit 102, the photo printing is judged to be intended through an acknowledgment that the present instruction indicates “printing on a sheet of photo paper”. Also, the photo printing can also be judged to be intended through an acknowledgment that the instruction from the user indicates “borderless printing”.

Next, the transmission/reception unit 105 of the DTV 100 transmits the generated print content to the printer 150 (S207 and S251).

On the basis of this, the image data determination unit 152 of the printer 150 judges whether or not the image data included in the print content can be used for the printing (i.e., whether or not an abnormality is present) (S252). When the image data is judged to be usable for the printing (S252: No), normal printing is performed (S256).

When the image data is abnormal (S252: Yes) and turns out to be unusable for the printing, the photo tag judgment unit 153 of the printer 150 checks whether or not the photo tag is present. When the photo tag is present (S253: Yes), the photo printing operation that corresponds to the case where the image data is abnormal is performed (S254). For example, nothing is carried out and the processing is terminated. Alternatively, no printing operation is performed on a sheet of paper, which is then discharged with a page being left blank. Or, no printing operation is performed on a sheet of paper, and the LED blinks to notify the user that the image data is abnormal. When the photo tag is not present (S253: No), the photo tag judgment unit 153 judges that the photo printing is not intended and alternative characters are laid out to the position of the image that cannot be printed (S255). Then, the alternative characters are printed out together with the rest (text, for example) of the print content (S256). It should be noted that the judgment as to whether or not the photo printing is intended is made prior to the printing operation performed on the sheet by the printer. Note that the alternative characters are generated by an alternative representation generation means (not illustrated). The alternative characters are generated from the file name and the path name of the present image data and explanatory text indicating that they are alternative characters. Also note that instead of the alternative characters, marks may be used for indicating that they are alternatives.

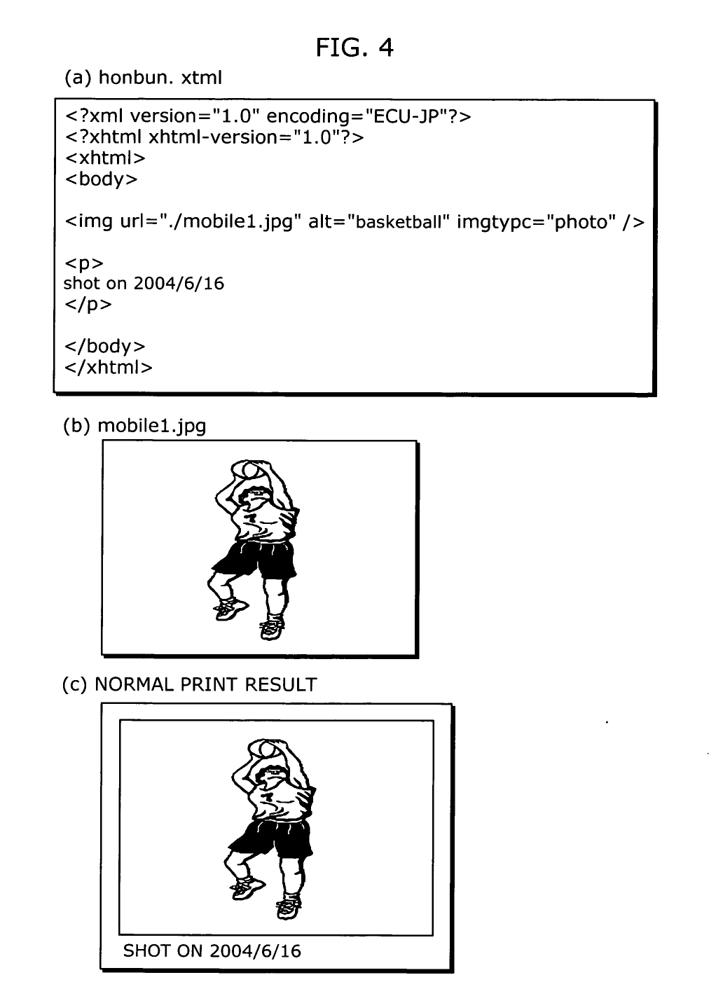

FIGS. 4(a) to 4(c) are diagrams showing respective examples of: the print content generated by the above print content generation unit 103; the image data; and the print result. FIG. 4(a) is a diagram showing an example of a file “honbun.xhtml” described in XHTML, the file including an instruction as to the layout in the case of printing as well as text to be printed. FIG. 4(b) is a diagram showing an example of an image to be inserted according to the layout instructed in the above-mentioned “honbun.xhtml” (the name of the file relating to the above image data is “mobile1.jpg”). FIG. 4(c) is a diagram showing a print result in a case where the printing is normally performed on the basis of the examples shown in FIGS. 4(a) and 4(b).

The photo tag is a description “imgtype=“photo”” in FIG. 4(a), to be more specific.

Suppose here that one set of print content includes a plurality of sets of image data and that a photo tag is described in one of the plurality of sets of image data. Here, suppose also that the image data is judged to be abnormal for the printing of the present print content. In this case, the photo printing operation that corresponds to the case where the image data is abnormal (such as the operation to discharge a blank sheet without performing the operation to print the image on the sheet, or the operation to notify the user of the abnormality by means of the blinking of the LED or the like without performing the printing operation) is performed even when the rest of the sets of image data have no photo tags. Then, the printing operation is terminated. This is because the presence of one set of image data with a photo tag indicates a high possibility of using a sheet of costly photo paper and, thus, such operation specifications are offered in order to avoid the case where the alternative characters or the like are printed and a sheet of costly photo paper is wastefully used.

It should be noted that when image data with a photo tag is present on a page in the case of specifications whereby a photo tag is included for each set of image data, the photo printing operation that corresponds to the case where the image data is abnormal may be performed on that page. It should be noted that when one set of image data with a photo tag is present in the case of specifications whereby a photo tag is included for each set of print content, the photo printing that corresponds to the case where the image data is abnormal is performed on all pages for the present print content.

As explained so far, according to the print system of the present embodiment, the details of the “instruction to perform the photo printing” defined in a description language, such as XHTML, are notified to the printer 150 in accordance with the images of print objects. Accordingly, when the image data cannot be printed, the system can avoid the case where the alternative characters and the rest of the data are printed and a sheet of costly photo paper is wasted.

It should be noted that although the intention of photo printing is included in the print content in the present embodiment, the DTV 100 may notify the printer 150 of this using a command formed separately from the content.

### (SECOND EMBODIMENT)

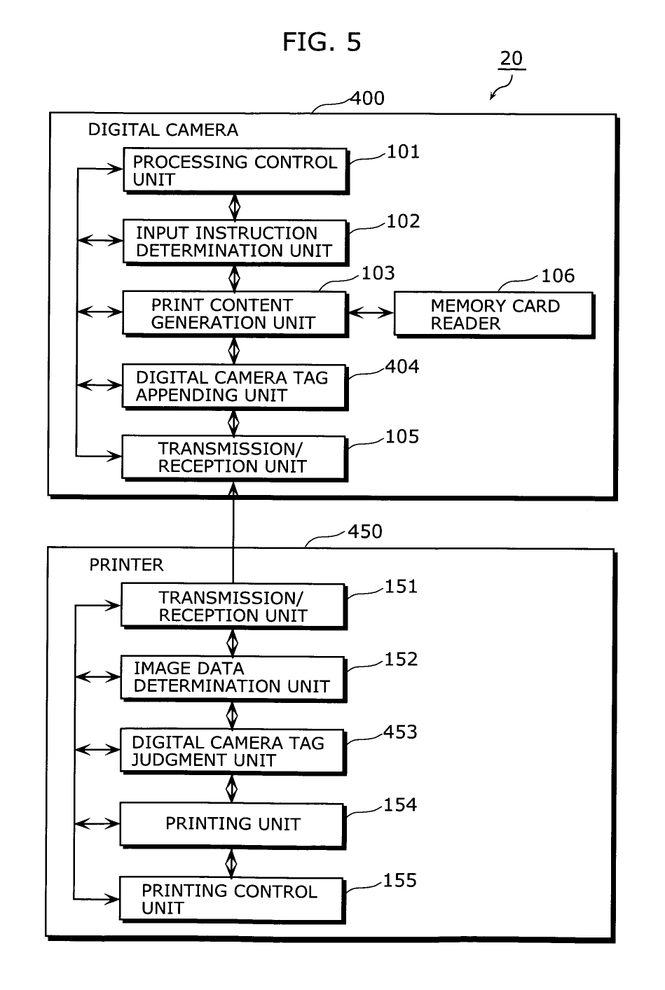

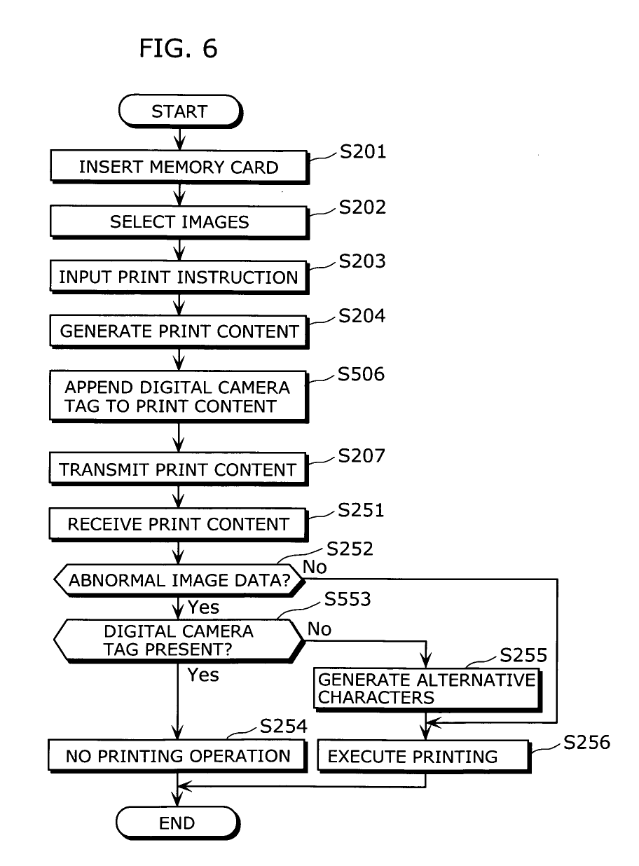

In the first embodiment, the explanation was given as to the case where the “instruction to perform the photo printing” is appended to the print content. In the present embodiment, meanwhile, an explanation is given as to a case where an “indication that a host apparatus is a dedicated photo printer” is appended to the print content, with reference to FIG. 5 and FIG. 6. It should be noted that the same functional components and the same steps as in the first embodiment are assigned the same numerals in the present embodiment, and so the explanations about them are omitted.

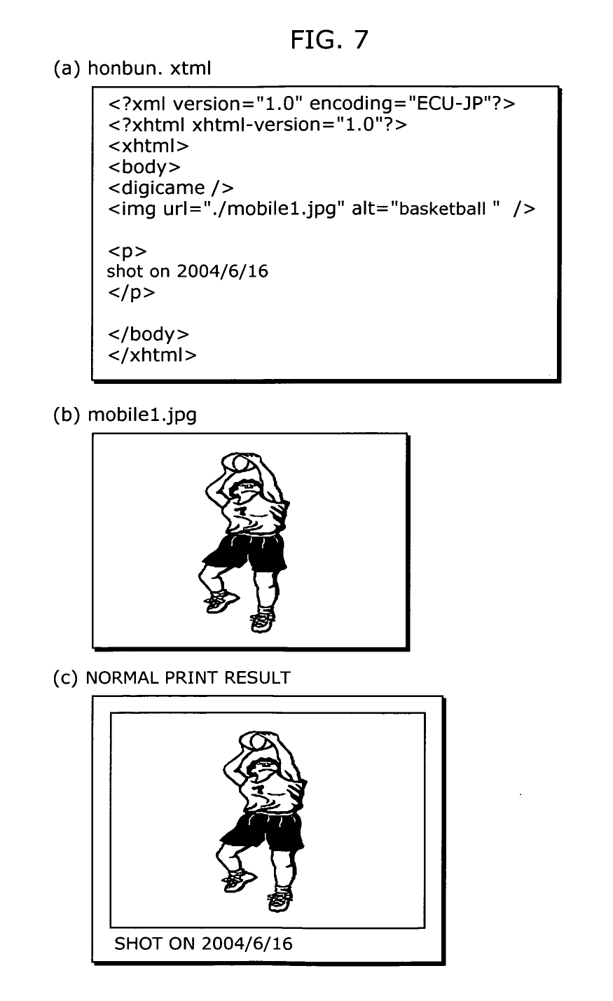

FIG. 5 is a block diagram showing a function structure of a print system 20 of the present embodiment. In FIG. 5, a digital camera tag appending unit 404 of a digital camera 400 has a function to append a “digital camera tag” to print content generated by the DSC. To be more specific, the digital camera tag is described as <digicame/> in FIG. 7(a).

A digital camera tag judgment unit 453 of a printer 450 checks whether or not a digital camera tag is described in the print content.

FIG. 6 is a flowchart showing a flow of processing performed by the print system 20 of the present embodiment.

After acquiring the print content generated by the digital camera 400 via a memory card reader 106 or the like, the digital camera tag appending unit 404 appends the digital camera tag to the print content (S506). It is preferable that the tag is appended to the part between <head> tags or to the part immediately below a <body> tag.

An image data determination unit 152 of the printer 450 checks image data included in the print content received from the digital camera 400 to verify whether or not the image data is abnormal (i.e., whether or not the image data can be used for the printing). When the image data is judged to be abnormal, the digital camera tag judgment unit 453 checks whether or not a digital camera tag is present in the print content (S553). It should be noted that this check may be carried out prior to the check of the image data. When the digital camera tag is described in the print content, the printer 450 performs the same operation as in the case where the photo tag is described in the first embodiment.

As explained so far, according to the print system of the present embodiment, the “indication that a host apparatus is a dedicated photo printer” defined in a description language, such as ML, is notified to the printer in accordance with the images of the print objects. Accordingly, when the image data cannot be printed, the system can avoid the case where the alternative characters are printed and prevent a sheet of costly photo paper from being wasted.

### (THIRD EMBODIMENT)

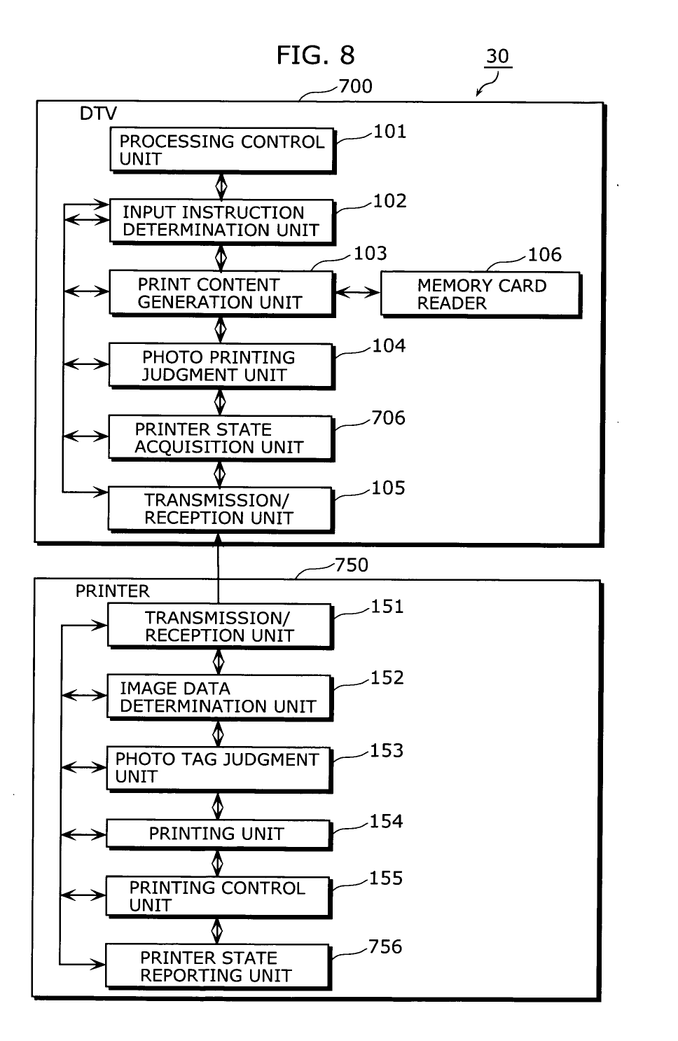

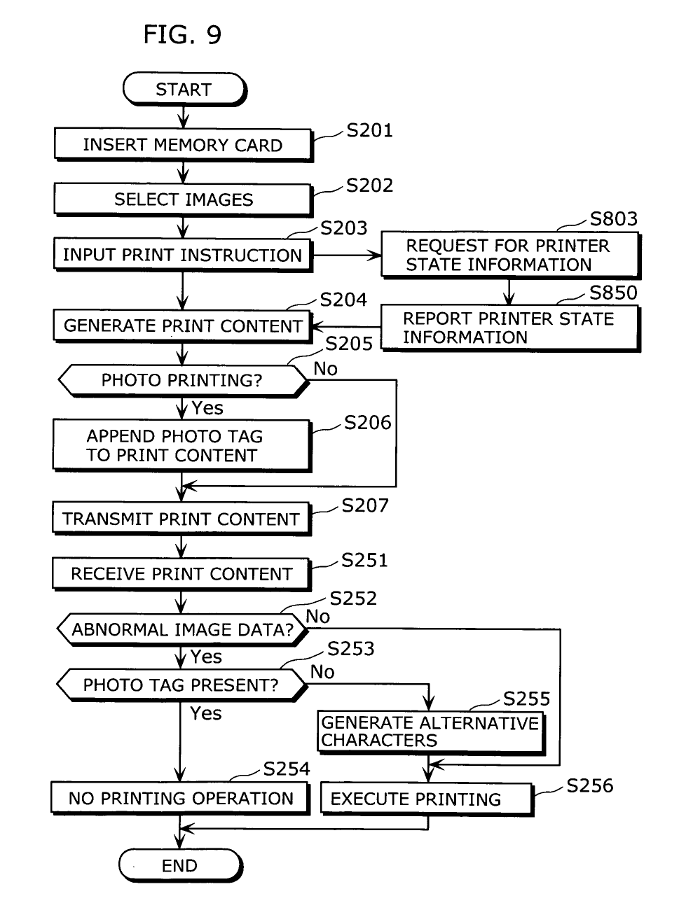

In the first embodiment, an explanation was given as to the case where the “instruction to perform the photo printing” is appended to the print content. In the present embodiment, meanwhile, an explanation is given as to a case where an “indication that photo ink tanks are installed in the printer” is appended to the print content, with reference to FIG. 8 and FIG. 9. It should be noted that the same functional components and the same steps as in the first embodiment are assigned the same numerals in the present embodiment, and so the explanations about them are omitted.

FIG. 8 is a block diagram showing a function structure of a print system 30 of the present embodiment.

A printer state acquisition unit 706 of a DTV 700 makes a request to a printer state reporting unit 756 of a printer 750 for state information, regarding the printer 150, that includes types of the installed ink tanks. Then, the printer state acquisition unit 706 manages the printer state information sent from the printer 750. This printer state information will be used in a judgment made by a photo printing judgment unit 104.

FIG. 9 is a flowchart showing a flow of processing performed by the print system 30 of the present embodiment.

When a print instruction is inputted by the user via an input instruction determination unit 102 (S203), the printer state acquisition unit 706 of the DTV 700 makes a request to the printer state reporting unit 756 of the printer 750 for the state information, regarding the printer 750, that includes types of the installed ink tanks (S803). The printer state reporting unit 756 reports the printer state information (S850). Then, the printer state acquisition unit 706 manages the printer state information sent from the printer 750. It should be noted that the timing to request for and acquire the printer state information is not limited to the time when the print instruction is inputted, as long as it is before the judgment as to whether or not the photo printing is intended is made.

After the generation of the print content, the photo printing judgment unit 104 references to the types of the ink tanks included in the printer state information and judges, when the photo ink tanks are installed in the printer 150, that the photo printing is intended (S205). Then, the photo printing judgment unit 104 appends a photo tag to the print content (S206).

### (FOURTH EMBODIMENT)

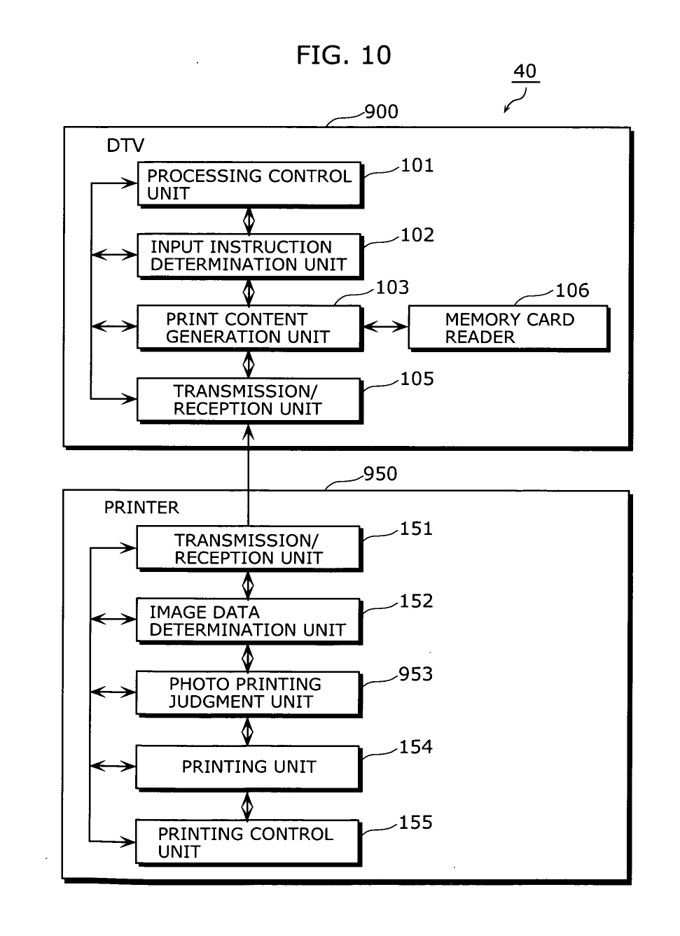

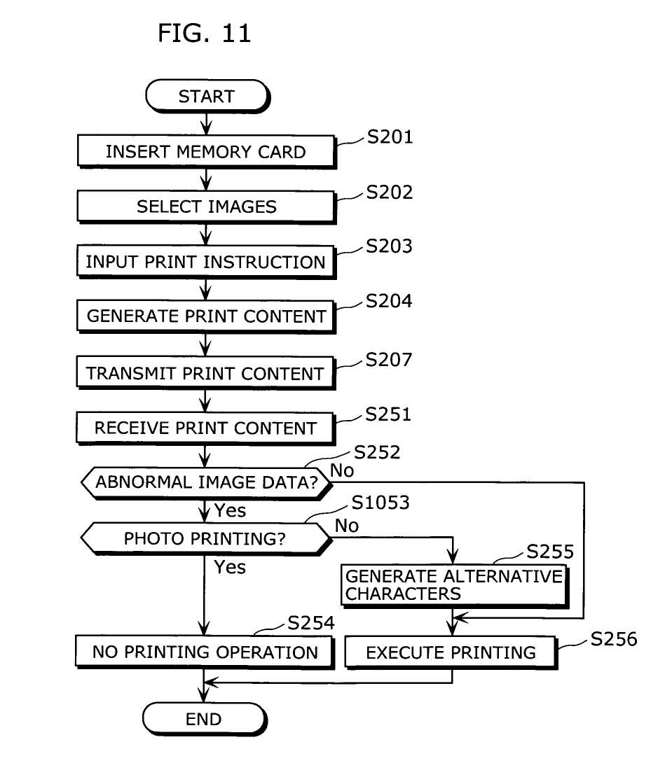

In the first embodiment, whether or not the photo printing is intended was judged by the DTV (host apparatus) side. In the present embodiment, meanwhile, an explanation is given as to a case where the judgment is made by the printer side, with reference to FIG. 10 and FIG. 11. It should be noted that the same functional components and the same steps as in the first embodiment are assigned the same numerals in the present embodiment, and so the explanations about them are omitted.

FIG. 10 is a block diagram showing a function structure of a print system 40 of the present embodiment.

A photo printing judgment unit 953 shown in FIG. 10 judges whether or not the printing to be performed is intended for photo printing by reference to printer state information, regarding a printer 950, that is managed by a printer control unit 155.

FIG. 11 is a flowchart showing a flow of processing performed by the print system 40 of the present embodiment.

When the image data determination unit 152 judges that the image data cannot be used for the printing for some reason, such as an abnormality in the data, the photo printing judgment unit 953 acquires a “type of loaded paper” included in the printer state information from the printing control unit 155 and judges, when the type of paper is “photo paper”, that the photo printing is intended (S1053). Then, the photo printing operation that corresponds to the case where the image data is abnormal is performed (S254). It should be noted that the present printer 950 has a photo printing judgment table (not illustrated) which shows correspondences between a “type of installed paper” and whether or not the current paper is to be used for printing that is intended for photo printing. The types of paper to be used for printing that is intended for photo printing include “glossy paper”, “ink-jet paper”, “sticker paper”, “dye sublimation print paper”, “postcard paper” and “New Year's greeting card paper”, in addition to the stated “photo paper”.

Moreover, there may be cases where: printing is performed on a jacket of an information recording medium, such as a CD-R, a DVD-R, or an SD card; and label printing is performed on a surface of the information recording medium itself. These media may also be categorized as print media used for photo printing.

It should be noted that there is another method for judging whether or not photo printing is intended. For example, when a “print setting” included in the printer state information indicates “borderless printing”, it can be judged that the current printing is intended for “photo printing”. Moreover, when the host apparatus connected to the printer 950 is determined to be an apparatus designed specifically for photo printing, such as a digital camera, from the printer state information, it can also be judged that the current printing is intended for “photo printing”. Here, the type of a port from which the print content is transmitted may be substituted for the type of the host apparatus connected to the printer 950. For example, when the print content is received by a USB port of the printer 950, it can be judged that the current printing is intended for “photo printing”.

As described so far, according to the print system of the present embodiment, whether or not photo printing is intended can be judged only by the printer side without necessity of receiving any information from the host apparatus. Accordingly, the case where a sheet of costly photo paper is wasted can be prevented from happening.

### (FIFTH EMBODIMENT)

In the first to fourth embodiments, the explanations have been given as to the cases relating to the method by which the host apparatus side or the printer side judges whether or not “photo printing is intended”. In the present embodiment, an explanation is given as to another judgment method.

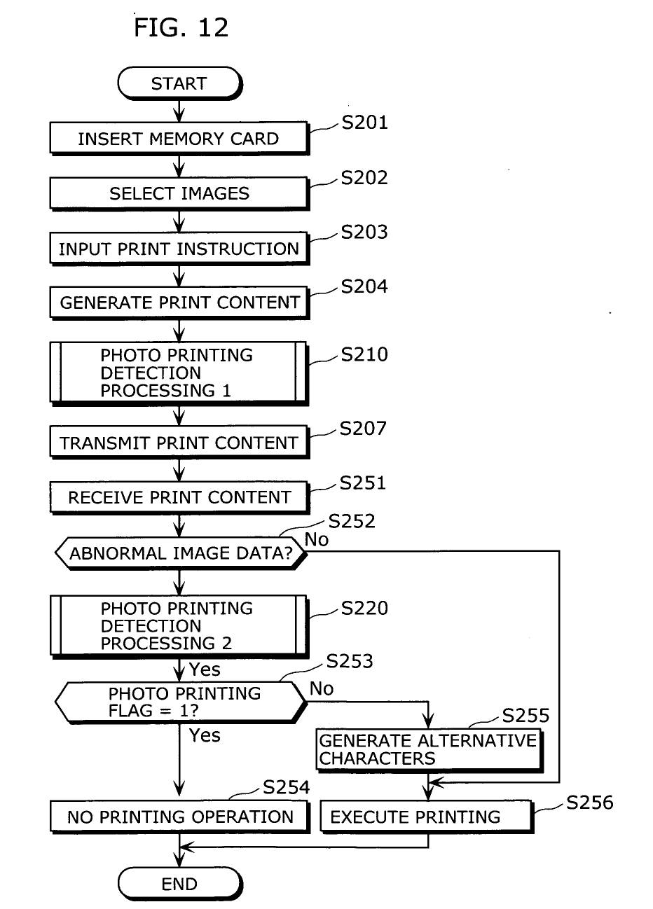

FIG. 12 is a flowchart showing a flow of processing performed by a print system of the present embodiment. It should be noted that the steps in FIG. 12 which are the same as those in FIG. 3 of the first embodiment are assigned the same numerals, and so will not be explained.

When the print content is generated, the host apparatus judges “whether or not photo printing is intended” and executes photo printing detection processing 1 (S210) in order to inform the printer of the result.

Meanwhile, the printer executes photo printing detection processing 2 (S220) in order to judge “whether or not photo printing is intended” on the basis of the print content received from the host apparatus or on the basis of the state of the printer itself.

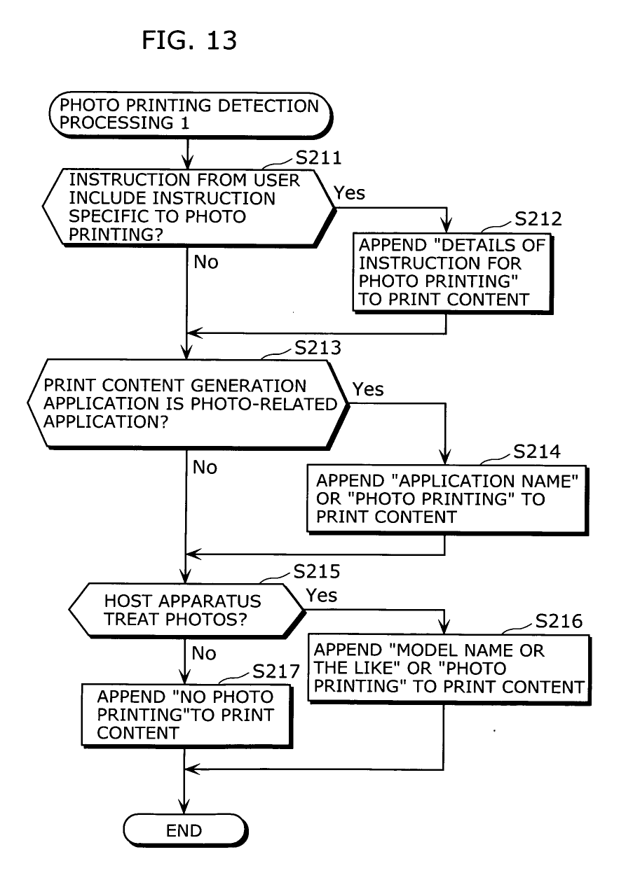

FIG. 13 is a flowchart showing details of the above photo printing detection processing 1 shown in FIG. 12. First, when the instruction from the user includes an instruction specific to photo printing (S211: Yes), the host apparatus appends the “details of instruction for photo printing” to the print content (S212). For example, an instruction such as “print image quality=beautiful” or “print type=borderless” is included, it is judged that “photo printing is intended”.

Moreover, when the instruction from the user does not include an instruction specific to photo printing (S211: No) and a print content generation application is an application relating to photos (S213: Yes), the host apparatus appends an “application name” or“photo printing” to the print content (S214). As examples of the photo-related application, there are retouching software for retouching the image data and photo viewer software for displaying images on a PC or a TV. In addition, even when the software itself is for general purpose use, the same processing is performed when a function of printing on a label or jacket of a CD or a DVD, or a function of printing on a surface of a CD-R disc is used.

Furthermore, when the print content generation application is not a photo-related application and the host apparatus is a model which treats photos (S215: Yes), the host apparatus also appends a “model name or the like” or “photo printing” to the print content (S216).

When none of the above is applied (S215: No), the host apparatus appends “no photo printing” to the print content (S217). It should be noted that “no photo printing” is not necessarily appended as long as there is an agreement between the host apparatus and the printer that no description means no photo printing.

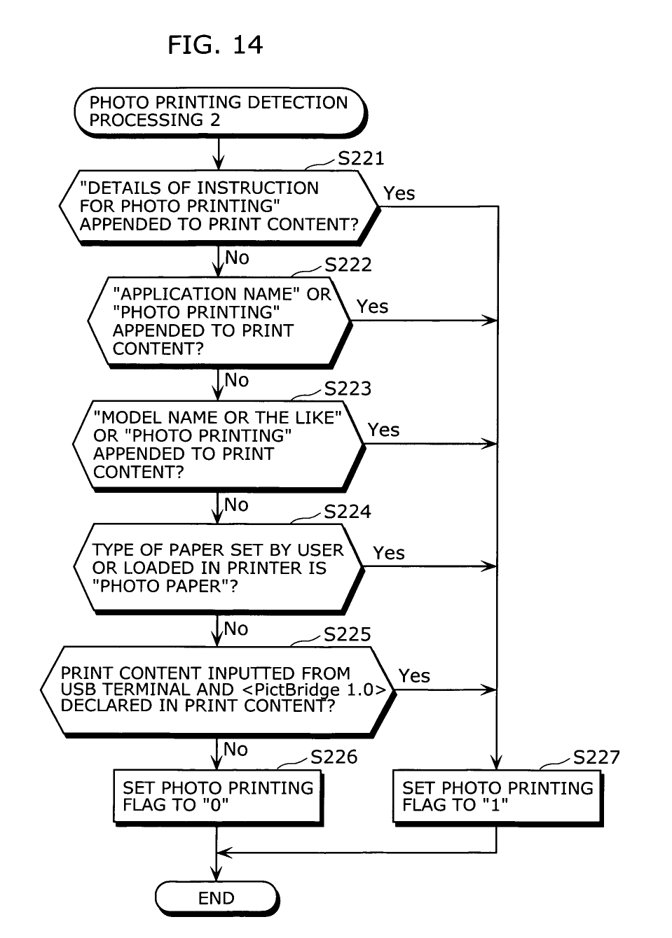

FIG. 14 is a flowchart showing details of the photo printing detection processing 2 shown in FIG. 12.

When the “details of instruction for photo printing” is appended to the print content (S221: Yes); when the “application name” or “photo printing” is appended to the print content (S222: Yes); when the “model name or the like” is appended to the print content (S223: Yes); when the type of paper set by the user or the type of paper loaded in the printer is photo paper (S224: Yes); or when the host apparatus and the printer perform printing using a protocol for photo printing, such as DPOF (Digital Print Order Format) or Pictbridge (when the protocol is Pictbridge, commands and data are transmitted via a USB and also there is a declaration of <Pictbridge 1.0> in the data transmitted from the host apparatus) (S225: Yes), the printer sets a “photo printing flag” to “1” (S227). In cases where a value of this photo printing flag is “1”, only when the image data is abnormal, the photo printing operation that corresponds to such a situation is performed. Meanwhile, in the cases other than the above, the “photo printing flag” is set to “0” (S226).

As described so far, according to the print system of the present embodiment, the host apparatus side and the printer side can judge whether or not photo printing is intended using various kinds of methods, thereby preventing the case where a sheet of costly photo paper is wasted from happening.

### INDUSTRIAL APPLICABILITY

The host apparatus of the present invention is useful as a host apparatus which transmits print content including image data generated and compressed on the basis of an image shot by an electronic image pickup device or the like, to a print apparatus. Moreover, the printer of the present invention is useful as a print apparatus or the like which receives the print content, decompresses it as appropriate, and produces a printed output including the image.

1. A print system comprising:
a print content generation unit operable to generate or acquire print content that includes a control code and image data;
an image data determination unit operable to determine whether or not the image data included in the generated or acquired print content can be used for printing;
a photo printing judgment unit operable to judge whether or not the printing to be performed using the print content is intended for photo printing; and
a printing control unit operable to change details of printing processing in accordance with a determination result given by said image data determination unit and a judgment result given by said photo printing judgment unit.

2. The print system according to claim 1,
wherein said printing control unit is operable to abort the printing to be performed using the print content, when said image data determination unit determines that the image data cannot be used for the printing and said photo printing judgment unit judges that the photo printing is intended.

3. The print system according to claim 2,
wherein nothing is printed when the printing is aborted.

4. The print system according to claim 1,
wherein said printing control unit includes
an alternative representation generation unit operable to generate or store an alternative representation that replaces the image data in the printing processing,
wherein said alternative representation generation unit is operable to generate a character or a mark that replaces the image when said image data determination unit determines that the image data cannot be used for the printing and said photo printing judgment unit judges that the photo printing is not intended, and
said printing control unit is operable to replace a print part of the image data included in the print content with a print of the alternative representation.

5. The print system according to claim 1, further comprising
a printing unit operable to perform the printing on a print medium using the print content,
wherein the determination by said image data determination unit as to whether or not the image data can be used for the printing and the judgment by said photo printing judgment unit as to whether or not the photo printing is intended are made before the printing unit performs the printing on the print medium.

6. The print system according to claim 1,
wherein said print content generation unit is operable to generate or acquire the print content including the control code in which a photo tag indicating the photo printing is described, and
said photo printing judgment unit is operable to judge that the photo printing is intended when the photo tag is included in the control code.

7. The print system according to claim 1,
wherein said print content generation unit is operable to generate or acquire the print content including the control code in which a name of a photo printing application program is described, and
said photo printing judgment unit is operable to judge that the photo printing is intended when the name of the photo printing application program is included in the control code.

8. The print system according to claim 1, further comprising
an input instruction determination unit operable to receive an instruction from a user and to determine whether or not the received instruction is an instruction specific to the photo printing,
wherein said photo printing judgment unit is operable to judge that the photo printing is intended when the received instruction is judged to be the instruction specific to the photo printing.

9. The print system according to claim 8,
wherein said photo printing judgment unit is operable to judge that the photo printing is intended when the received instruction is judged to be an instruction to print one image per piece of a print medium.

10. The print system according to claim 8,
wherein said photo printing judgment unit is operable to judge that the photo printing is intended when the received instruction is judged to be an instruction to use photo paper.

11. The print system according to claim 8,
wherein said photo printing judgment unit is operable to judge that the photo printing is intended when the received instruction is judged to be an instruction to request borderless printing.

12. The print system according to claim 1,
wherein said photo printing judgment unit is operable to judge that the photo printing is intended when the print content is generated or acquired by a digital camera.

13. The print system according to claim 1,
wherein said image data determination unit is operable to determine whether or not the image data can be used for the printing on the basis of whether or not the image data can be acquired from a host apparatus.

14. The print system according to claim 1,
wherein said image data determination unit is operable to determine whether or not the image data can be used for the printing on the basis of whether or not information indicating a print inhibition is appended to the image data.

15. The print system according to claim 1,
wherein said image data determination unit is operable to determine whether or not the image data can be used for the printing on the basis of whether or not a data format of the image data can be handled by a print apparatus which performs the printing.

16. The print system according to claim 1,
wherein said image data determination unit is operable to determine whether or not the image data can be used for the printing on the basis of whether or not the image data has an abnormality.

17. A print apparatus comprising:
a print content reception unit operable to receive print content that includes a control code and image data;
an image data determination unit operable to determine whether or not the image data included in the received print content can be used for printing;
a photo printing judgment unit operable to judge whether or not the printing to be performed using the print content is intended for photo printing; and
a printing control unit operable to change details of printing processing in accordance with a determination result given by said image data determination unit and a judgment result given by said photo printing judgment unit.

18. A print method comprising:
a print content reception step of receiving print content that includes a control code and image data;
an image data determination step of determining whether or not the image data included in the received print content can be used for printing;
a photo printing judgment step of judging whether or not the printing to be performed using the print content is intended for photo printing; and
a printing control step of changing details of printing processing in accordance with a determination result given in said image data determination step and a judgment result given in said photo printing judgment step.

19. A program for a print apparatus, said program being capable of causing a computer to execute:
a print content reception step of receiving print content that includes a control code and image data;
an image data determination step of determining whether or not the image data included in the received print content can be used for printing;
a photo printing judgment step of judging whether or not the printing to be performed using the print content is intended for photo printing; and
a printing control step of changing details of printing processing in accordance with a determination result given in said image data determination step and a judgment result given in said photo printing judgment step.

20. A computer-readable recording medium which stores a computer-executable program, said program comprising:
a print content reception step of receiving print content that includes a control code and image data;
an image data determination step of determining whether or not the image data included in the received print content can be used for printing;
a photo printing judgment step of judging whether or not the printing to be performed using the print content is intended for photo printing; and
a printing control step of changing details of printing processing in accordance with a determination result given in said image data determination step and a judgment result given in said photo printing judgment step.

21. A print apparatus equipped with a printing unit which performs printing on a print medium using print content, said print apparatus comprising:
an image data determination unit operable to determine whether or not image data included in the print content can be used for the printing;
a medium detection unit operable to detect a type of the print medium which is used by said printing unit;
a photo print media table in which types of print media used for photo printing are described;
a photo printing judgment unit operable to judge whether or not the photo printing is intended, on the basis of details described in said photo print media table and the type of the print medium detected by said medium detection unit; and
a printing control unit operable to abort the printing when said image data determination unit judges that the image data cannot be used for the printing and said photo printing judgment unit judges that the photo printing is intended.

22. The print apparatus according to claim 21,
wherein said photo printing judgment unit is operable to judge that the photo printing is intended, when the type of the print medium is one of photo paper, glossy paper, ink-jet paper, sticker paper, dye sublimation print paper, and postcard paper.

23. The print apparatus according to claim 21,
wherein said photo printing judgment unit is operable to judge that the photo printing is intended, when the type of the print medium is a label of an information recording medium.

24. The print apparatus according to claim 21,
wherein nothing is printed on the print medium when the printing is aborted.
